(19) United States
(12) Patent Application Publication
(10) Pub. No.: US 2008/0262726 A1
(43) Pub. Date: Oct. 23, 2008

(54) METHOD AND GENERATOR FOR GENERATING A SPREAD-SPECTRUM SIGNAL

(76) Inventor: NIGEL SHERIDEN HOULT, Woodley (GB)

Correspondence Address: CANTOR COLBURN, LLP, 20 Church Street, 22nd Floor, Hartford, CT, 06103, US

(21) Appl. No.: 11/738,006

(22) Filed: Apr. 20, 2007

(51) Int. Cl. G01S 5/00

(52) U.S. Cl. 701/213; 701/207

(57) ABSTRACT

A method of generating a spread-spectrum signal in a navigation system comprises the steps of providing a carrier wave and a modulation waveform and modulating the carrier wave with the modulation waveform. The modulation waveform comprises a so-called anti-phase linear combination of a BOC(1,1) waveform and a BOC(m,1) waveform, expressible as α·BOC(1,1)−β·BOC(m,1), where m represents an even integer number, α and β are non-zero coefficients of the same sign, indicating the relative power split between the BOC(1,1) waveform and the BOC(m,1) waveform.

### TECHNICAL FIELD

The present invention generally relates to the field of signal modulation, in particular with regard to satellite navigation systems. The invention further concerns a method for producing a spread-spectrum signal and appropriate techniques for receiving such a spread-spectrum signal, in particular with regard to satellite navigation systems.

### BRIEF DESCRIPTION OF RELATED ART

Satellite positioning systems like, for instance, GPS (Global Positioning System), Galileo, GLONASS, QZSS and others use navigation signals referred to as spread-spectrum signals.

In the case of GPS, the spread-spectrum signals are transmitted in the following frequency bands: the L1 band, centred on the frequency of 1575.42 MHz, and L2, centred on 1227.6 MHz. Frequency band L5, centred on 1176.45 MHz, will be added in the course of modernization of GPS signal structure. The satellites of the European Galileo system will transmit spread-spectrum signals in frequency bands E2-L1-E1 (which corresponds to a broadened L1 band), L5 (which is often referred to as E5a in the context of Galileo), E5b (centred on 1207.14 MHz) and E6 (centred on 1278.75 MHz).

The spread-spectrum signals are obtained by modulating the carrier waves (i.e. sine waves oscillating at the respective centre frequency) with a modulation waveform, according to a modulation scheme. To warrant the interoperability of GPS and Galileo, The United States of America and the European Union have concluded an agreement on the modulation schemes implemented in the L1 frequency band by Galileo and GPS, respectively.

A candidate for the modulation scheme of Galileo's Opens Service (OS) signal in the L1 frequency is known as Composite Binary Offset Carrier (CBOC) modulation. The modulation waveform that modulates the carrier wave is a linear combination of a first and a second Binary Offset Carrier waveform. Such CBOC modulation waveform may be considered as a particular member of the family of composite modulation waveforms known from the international patent application WO 2006/075018 A1, incorporated herein by reference.

### BRIEF SUMMARY OF THE INVENTION

According to a first aspect of the invention, a method of generating a spread-spectrum signal in a navigation system comprises the steps of providing a carrier wave and a modulation waveform and modulating the carrier wave with the modulation waveform. The modulation waveform comprises a linear combination of a BOC(1,1) waveform and a BOC(m,1) waveform, expressible as α·BOC(1,1)−β·BOC(m,1), where m represents an even integer number, α and β are non-zero coefficients of the same sign, indicating the relative power split between the BOC(1,1) waveform and the BOC(m,1) waveform. Such linear combination in which the coefficient of the BOC(1,1) waveform (here: α) and the coefficient of the BOC(m,1) waveform (here: −β) are of opposite sign will hereinafter be referred to as “anti-phase” linear combination. It will be appreciated that the anti-phase linear combination of the BOC(1,1) waveform and the BOC(m,1) waveform gives a significant benefit in navigation performance and ranging accuracy when compared to the corresponding “in-phase” linear combination, i.e. α·BOC(1,1)+β·BOC(m,1), where the coefficient of the BOC(1,1) waveform (here: α) and the coefficient of the BOC(m,1) waveform (here: β) are of the same sign.

For the purposes of the present, the following definition of a BOC(m,n) waveform (which is a function of time, t) shall apply:

BOC(m,n)(t)=Cₙ(t)·sign[sin(2πf_{sc}t)] (1)

where Cₙ(t) is a pseudo-random noise code at a chip rate of n×1.023 mega-chips per second (Mcps), which can take the values of +1 or −1 and where f_{sc} represents the sub-carrier frequency of m×1.023 MHz. In case of the Galileo OS L1 signal, the chip rate is fixed to 1.023 Mcps. A BOC(1,1) waveform thus represents a spreading code at this chip rate, which is modulated by a binary sub-carrier whose frequency corresponds to this chip rate.

In the present context, the term “linear combination” implies that the BOC(1,1) and the BOC(m,1) waveforms making up the linear combination have a common pseudo-random noise code. The above-mentioned anti-phase linear combination, noted CBOC(m,1), may be expressed as:

$$\begin{matrix}CBOC ( m , 1 ) ( t ) = α \cdot BOC ( 1 , 1 ) ( t ) - β \cdot BOC ( m , 1 ) ( t ) \\ = {C}_{1} ( t ) \cdot ( α \cdot x ( t ) - β \cdot y ( t ) )\end{matrix} \qquad ( 2 )$$

where x(t)=sign[sin(2π·f₁·t)] and y(t)=sign[sin(2π·f₂·t)], with f₁=1.023 MHz and f₂=m×1.023 MHz. It shall be noted that at the beginning of each chip, the BOC(1,1) component and the BOC(m,1) component are of opposite sign. Preferably, m is chosen to be 6. The expression for the anti-phase linear combination is, in this case:

CBOC(6,1)=α·BOC(1,1)−β·BOC(6,1) (3)

where the t-dependency has not been written explicitly.

According to a preferred embodiment of the first aspect of the invention, the method of generating a spread-spectrum signal comprises broadcasting the modulated carrier wave from a satellite or a pseudolite.

According to a preferred embodiment, the modulation waveform includes a pilot signal and a data signal, wherein one of the pilot signal and data signal comprises the anti-phase linear combination and wherein the other of the pilot and data signal comprises another BOC(1,1) waveform. If the pilot signal comprises the anti-phase linear combination, the pilot signal (noted Pilot(t)) is formed by modulating the anti-phase linear combination with a (predetermined pseudo-random) pilot spreading code C_{P}(t): Pilot(t)=C_{P}(t)·(α·x(t)−β·y(t)), where the above definition of x(t) and y(t) applies. The data signal (noted Data(t)) may in this case be expressed as: Data(t)=D_{D}(t)·C_{D}(t)·x(t), where C_{D}(t) represents a (predetermined pseudo-random) data spreading code and D_{D}(t) the data in binary form. If the data signal comprises the anti-phase linear combination, the expressions “α·x(t)−β·y(t)” and “x(t)” must be exchanged for one another in the equations defining Pilot(t) and Data(t). It should be noted, however, that the case where the pilot comprises the anti-phase combination is preferred over the other case.

According to another preferred embodiment, one of the pilot signal and data signal comprises the anti-phase linear combination and the other of the pilot signal and data signal comprises an in-phase linear combination of a BOC(1,1) waveform and a BOC(m,1) waveform. The in-phase linear combination is expressible as α·BOC(1,1)+β·BOC(m,1), where the coefficient of the BOC(1,1) waveform (here α) and the coefficient of the BOC(m,1) waveform (here: β) are of the same sign. If the pilot signal comprises the anti-phase linear combination, the pilot signal can again be written as: Pilot(t)=C_{P}(t)·(α·x(t)−β·y(t)). The data signal Data(t) may in this case be expressed as: Data(t)=D_{D}(t)·C_{D}(t)·(α·x(t)+β·y(t)). If the data signal comprises the anti-phase linear combination, the expressions “α·x(t)−β·y(t)” and “α·x(t)+β·y(t)” must be exchanged for one another in the preceding equations. Again, the case where the pilot comprises the anti-phase combination is preferred over the other case.

According to a second aspect of the invention, it is proposed a method of determining a position, wherein a spread-spectrum signal generated according to the method described hereinbefore is received.

A third aspect of the invention concerns the spread-spectrum signal generated by the above method.

A fourth aspect of the invention concerns a spread-spectrum signal generator configured and arranged so as to provide such a spread-spectrum signal. Such a spread-spectrum signal generator may be implemented, for instance, on a satellite or a pseudolite further comprising a transmitter broadcasting the modulated carrier wave.

### BRIEF DESCRIPTION OF THE DRAWINGS

Further details and advantages of the present invention will be apparent from the following detailed description of several not limiting embodiments with reference to the attached drawings, wherein:

FIG. 1 is a representation of an in-phase linear combination of a BOC(1,1) waveform and a BOC(6,1) waveform;

FIG. 2 is a representation of an anti-phase linear combination of a BOC(1,1) waveform and a BOC(6,1) waveform;

FIG. 3 is a diagram of the power spectral densities of the Galileo L1 signal components for an in-phase CBOC(6,1) combination with 50%/50% power split between pilot and data signals and 1/11 of the total signal power in the BOC(6,1) component;

FIG. 4 is a diagram of the power spectral densities of the Galileo L1 signal components for an anti-phase CBOC(6,1) combination with 50%/50% power split between pilot and data signals and 1/11 of the total signal power in the BOC(6,1) component;

FIG. 5 is a diagram of the power spectral densities of the components of a baseline BOC(1,1) modulation, for comparison with FIGS. 3 and 4;

FIG. 6 is a diagram of the RMS bandwidth of a receiver using a matched reference as a function of receiver bandwidth for the reception of a baseline BOC(1,1) signal, an in-phase CBOC(6,1) signal and an anti-phase CBOC(6,1) signal;

FIG. 7 is a diagram of correlation peaks of an in-phase CBOC(6,1) signal and an anti-phase CBOC(6,1) signal for a representative receiver bandwidth;

FIG. 8 is a diagram of the RMS bandwidth of a receiver using a baseline BOC(1,1) signal as a reference as a function of receiver bandwidth for the reception of a baseline BOC(1,1) signal, an in-phase CBOC(6,1) signal and an anti-phase CBOC(6,1) signal;

FIG. 9 is a diagram of correlation peaks for a representative receiver bandwidth, corresponding to the case of FIG. 8.

### DETAILED DESCRIPTION WITH RESPECT TO THE FIGURES

Both the European Galileo and American Modernised-GPS navigation systems propose to use BOC sub-modulation in the common L1 frequency band, in a constant-envelope modulation scheme. For the European Galileo system it is also proposed to use BOC_{C}(15,2.5) modulation for the restricted (or non-public) part of the signal, known as the public regulated service or PRS, combined with the open service signal (OS) in a constant-envelope modulation scheme. This scheme causes an intermodulation or IM component to also be generated.

For a navigation receiver it can be shown that a higher RMS bandwidth in the ranging signal (spread-spectrum signal) results in better ranging accuracy in an AWGN (additive white Gaussian noise) channel, with increased ranging accuracy leading directly to improved positioning accuracy.

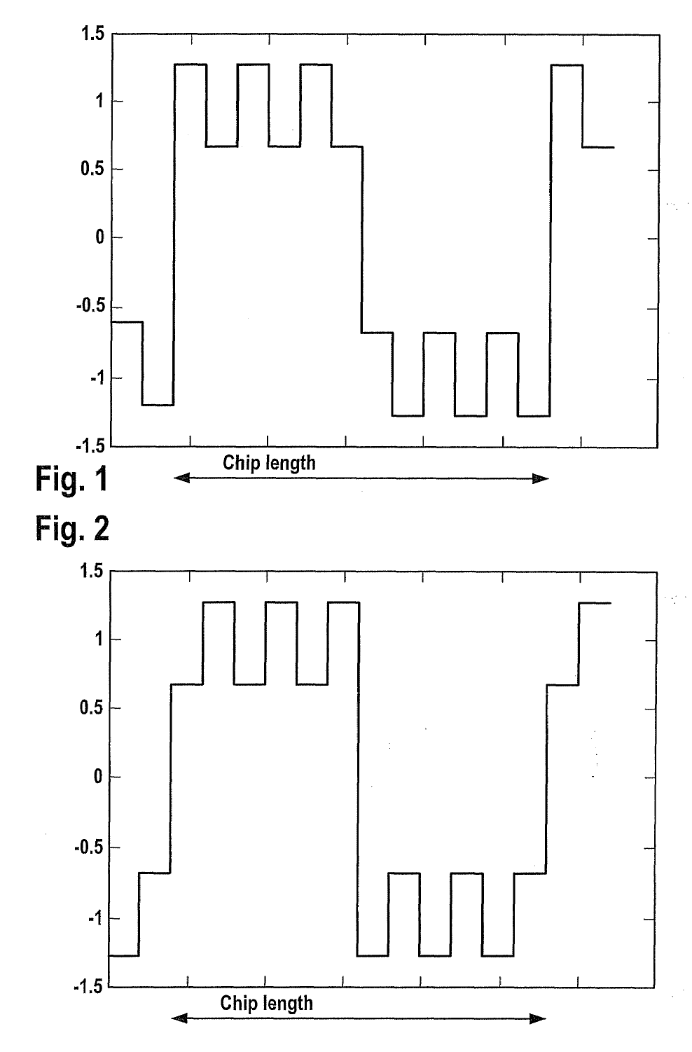

The RMS bandwidth of the open-service BOC(1,1) signal can be dramatically increased by applying a fraction of BOC(6,1) sub-modulation to the baseline BOC(1,1) sub-modulation. When a BOC(1, 1) waveform and a BOC(6, 1) waveform are linearly combined, there are two choices for the relative polarity of the signals, yielding the “anti-phase” and “in-phase” linear combinations as defined hereinbefore. For the in-phase combination, the BOC(1,1) component is of the same polarity as the BOC(6,1) component at the beginning of every chip, as shown in FIG. 1. For the anti-phase combination, the BOC(1,1) component and the BOC(6,1) component are of opposite polarity at the beginning of every chip, as shown in FIG. 2.

The BOC(6,1) waveform is preferably added in anti-phase to the BOC(1,1) waveform of the pilot signal. In addition to improving the RMS bandwidth this scheme also maintains compatibility with BOC(1,1)-only receiver designs, e.g. for low-cost consumer grade navigation receivers, and reduces interference from inter-modulation to the PRS or M-code component of the generated signal.

Let the following notations apply:
Tc Chip period of OS signal (1/1.023 μs=1/f₁);
Tc_{PRS} Chip period of public regulated service (PRS) signal (1/(2.5×1.023)μs);
C_{D} Data spreading code;
D_{D} Data in binary format;
C_{P} Pilot spreading code;
C_{PRS} PRS spreading code;
D_{PRS} PRS data signal;

$$\begin{matrix}\begin{matrix}x ( t ) = sign ( sin \frac{2 π t}{Tc} ) = sign ( sin ( 2 π \cdot {f}_{1} \cdot t ) ) ; \\ y ( t ) = sign ( sin \frac{2 π t}{Tc / 6} ) = sign ( sin ( 2 π \cdot {f}_{2} \cdot t ) ) = sign ( sin ( 2 π \cdot 6 {f}_{1} \cdot t ) ) ; \\ z ( t ) = sign ( cos \frac{2 π t}{{Tc}_{PRS} / 6} ) ; and\end{matrix} \\ BOCc ( 15 , 2.5 ) ( t ) = {C}_{PRS} \cdot z ( t ) .\end{matrix}$$

A first modulation scheme for the Galileo L1 signal is given by the equation:

s(t)=C_{P}{Px(t)−Qy(t)}+D_{D}C_{D}Rx(t)+jD_{PRS}C_{PRS}{Sz(t)+IM(t)} (4)

where P (taking the role of α), Q (taking the role of β) and R are positive constants depending on the power split, and:

$$S = \frac{\begin{matrix}\sqrt{1 - {( P + Q + R )}^{2}} + \sqrt{1 - {( P - Q + R )}^{2}} + \\ \sqrt{1 - {( P + Q - R )}^{2}} + \sqrt{1 - {( P - Q - R )}^{2}}\end{matrix}}{4} \qquad ( 5 )$$

The minus sign preceding Q in equation provides the anti-phase combination of the BOC(6,1) and the BOC(1,1). The so-called “intermodulation term”, IM(t), is defined by the following equation:

$$IM ( t ) = \frac{1}{4} z ( t ) \{ \begin{matrix}x ( t ) y ( t ) {C}_{P} {D}_{D} {C}_{D} ( \begin{matrix}\sqrt{1 - {( P - Q + R )}^{2}} - \\ \sqrt{1 - {( P + Q + R )}^{2}} - \\ \sqrt{1 - {( P - Q - R )}^{2}} + \\ \sqrt{1 - {( P + Q - R )}^{2}}\end{matrix} ) + \\ x ( t ) y ( t ) ( \begin{matrix}\sqrt{1 - {( P - Q + R )}^{2}} - \\ \sqrt{1 - {( P + Q + R )}^{2}} + \\ \sqrt{1 - {( P - Q - R )}^{2}} - \\ \sqrt{1 - {( P + Q - R )}^{2}}\end{matrix} ) + \\ {C}_{P} {D}_{D} {C}_{D} ( \begin{matrix}\sqrt{1 - {( P - Q + R )}^{2}} + \\ \sqrt{1 - {( P + Q + R )}^{2}} - \\ \sqrt{1 - {( P - Q - R )}^{2}} - \\ \sqrt{1 - {( P + Q - R )}^{2}}\end{matrix} )\end{matrix} \} \qquad ( 6 )$$

Since x(t) and y(t) have zero cross-correlation, as do C_{P} and D_{D}C_{D}, the power splits (at generation) are defined as follows:

$$\begin{matrix}\begin{matrix}\frac{OS}{PRS} = \frac{{P}^{2} + {Q}^{2} + {R}^{2}}{{S}^{2}} \\ \frac{Pilot}{Data} = \frac{{P}^{2} + {Q}^{2}}{{R}^{2}}\end{matrix} \\ \frac{y}{x} = \frac{{Q}^{2}}{{P}^{2} + {R}^{2}}\end{matrix} \qquad ( 7 )$$

For the case of equal power on data and pilot, 1/11 of the total power (i.e. 2/11 of the pilot power) in the BOC(6, 1) component, and the PRS component 3.0009 dB above the OS component before band-limiting (2 dB after band-limiting), the constants have the values:
P=0.358235;
Q=0.168874;
R=0.396044;
S=0.79124;
   and the intermodulation term may be expressed as:

IM(t)=0.1096x(t)y(t)z(t)C_{P}D_{D}C_{D}+0.1036x(t)y(t)z(t)−0.1939z(t)C_{P}D_{D}C_{D}. (8)

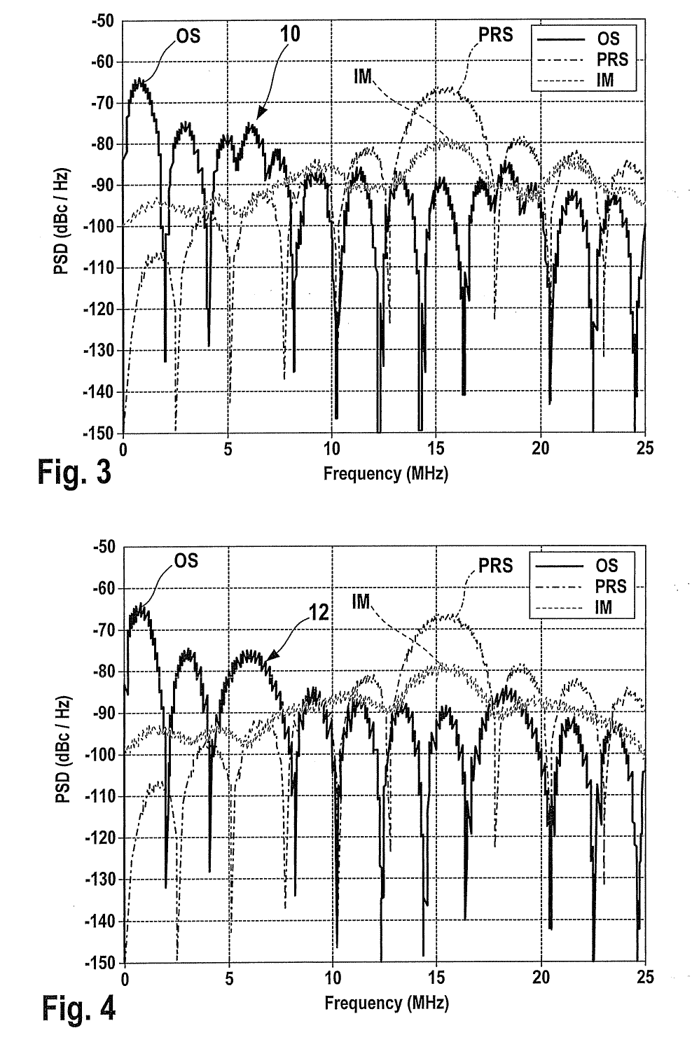

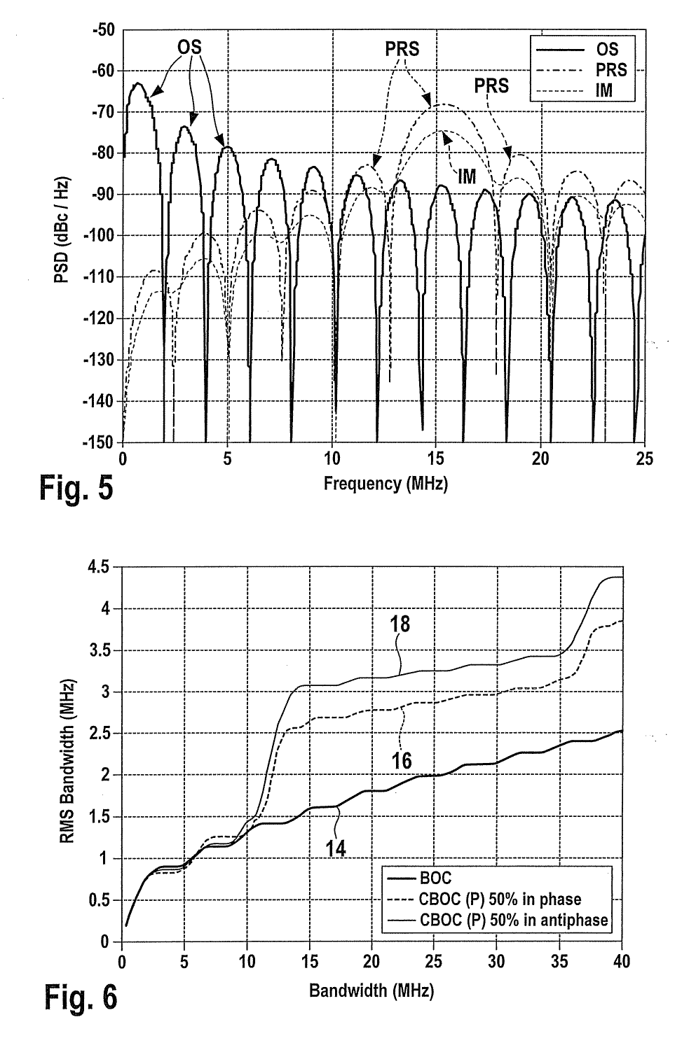

Conventionally, the BOC(6,1) component was added in-phase with the BOC(1,1) component, i.e. with the choice Q of the opposite sign to P in equation (4). It has been found, however, that the composite CBOC signal performance can be significantly improved if the BOC(6,1) is added in anti-phase to the BOC(1,1) component, i.e. if Q is of the same sign as P in equation (4). FIG. 3 shows the power spectrum of the different signal components (OS, PRS and IM) for the conventional in-phase combination (with P=0.358235 and Q=−0.168874), while FIG. 4 shows the power spectrum of the different signal components (OS, PRS and IM) for the anti-phase combination (with P=0.358235 and Q=−0.168874). For comparison, FIG. 5 shows the power spectrum of the baseline BOC(1,1) modulation (i.e. no BOC(6,1) component in the OS signal). As can be seen, the anti-phase combination (FIG. 4) exhibits a broader spectral peak (indicated at reference numeral 12) at 6 MHz from the centre frequency than the in-phase combination (peak indicated at reference numeral 10 in FIG. 3) and the baseline BOC(1,1) of FIG. 5. The additional power in this spectral peak causes an increase in the RMS bandwidth of the signal for receiver bandwidths greater than 12 MHz, as illustrated in FIG. 6. It should be noted that the use of the anti-phase CBOC(6,1) is beneficial regardless of the actual power split, expressed by the values of P, Q, R and S.

FIG. 6 shows the RMS bandwidth of a receiver using a matched reference against the baseline BOC(1,1) signal (curve 14), the in-phase CBOC(6,1) signal (curve 16) and the anti-phase CBOC(6,1) signal (curve 18). Both the in-phase and anti-phase CBOC(6,1) signals show significant improvement over the baseline BOC(1,1) once the receiver bandwidth exceeds 12 MHz. However the anti-phase CBOC(6,1) shows a considerable additional improvement over the use of in-phase CBOC(6, 1).

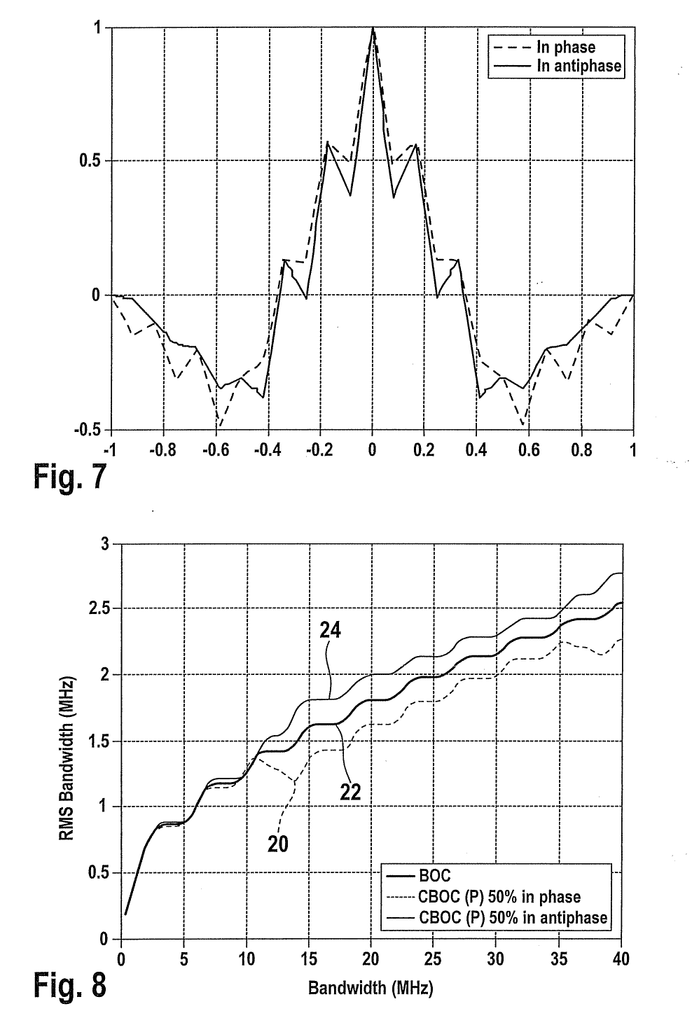

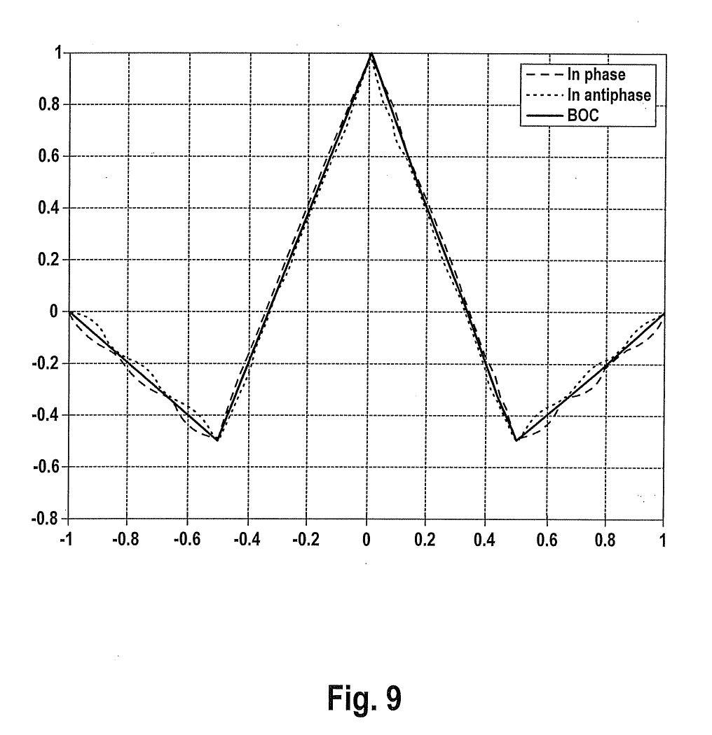

The corresponding correlation peak shapes are shown in FIG. 7 for a representative receiver bandwidth, confirming that tracking performance of the receiver will be improved by the sharper peak of the anti-phase CBOC(6,1) signal.

FIG. 8 illustrates the compatibility of the CBOC(6,1) signal against receivers using the baseline BOC(1, 1) signal as a reference. The in-phase CBOC(6,1) signal (curve 20) has a lower RMS bandwidth than the BOC(1, 1) signal (curve 22), while the anti-phase CBOC(6,1) maintains a performance advantage (curve 24). The negative slope that is visible on the in-phase curve is a result of the correlation peak flattening as more of the BOC(6, 1) signal is allowed through the filter.

The corresponding correlation peak shapes are shown in FIG. 5 for a representative receiver bandwidth. It may be seen that the anti-phase case gives a sharper peak than for BOC(1, 1), while the “in phase” case gives a flatter peak. The anti-phase CBOC(6,1) therefore provides better receiver tracking performance.

It shall be noted that the use of an anti-phase CBOC(6,1) is also beneficial for the following modulation scheme of the Galileo L1 signal:

$$\begin{matrix}\begin{matrix}s ( t ) = {C}_{P} \{ P \times ( t ) - Qy ( t ) \} + {D}_{D} {C}_{D} \{ P \times ( t ) + Qy ( t ) \} + \\ j {D}_{PRS} {C}_{PRS} \{ Sz ( t ) + IM ( t ) \} \\ where :\end{matrix} & ( 9 ) \\ \begin{matrix}P = \frac{cos {θ}_{1}}{2} \\ Q = \frac{cos {θ}_{2}}{2} \\ S = \frac{sin {θ}_{1} + sin {θ}_{2}}{2} = \frac{\sqrt{1 - 4 {P}^{2}} + \sqrt{1 - 4 {Q}^{2}}}{2}\end{matrix} & ( 10 )\end{matrix}$$

and where the intermodulation term is now given as:

$$\begin{matrix}IM ( t ) = {C}_{P} {C}_{D} {D}_{D} z ( t ) \frac{sin {θ}_{1} - sin {θ}_{2}}{2} \\ = {C}_{P} {C}_{D} {D}_{D} z ( t ) \frac{\sqrt{1 - 4 {P}^{2}} - \sqrt{1 - 4 {Q}^{2}}}{2} .\end{matrix} \qquad ( 11 )$$

It should be noted that in equation (9) the term “C_{P}·(P·x(t)−Q·y(t))” representing the pilot signal includes the anti-phase combination, while the term “D_{D}·C_{D}·(P·x(t)+Q·y(t))” representing the data signal includes the in-phase combination.

Given that x(t) and y(t) have zero cross-correlation, as do C_{P} and D_{D}C_{D}, the power splits (at generation) are defined as follows:

$$\begin{matrix}\frac{OS}{PRS} = \frac{2 ( {P}^{2} + {Q}^{2} )}{{S}^{2}} \\ \frac{y}{x} = \frac{{Q}^{2}}{{P}^{2}}\end{matrix} \qquad ( 12 )$$

For the case of equal power on data and pilot, 1/11 of the power of each in the BOC(6,1) component, and the PRS component 3.008 dB above the OS component before band-limiting (2 dB after band-limiting), the constants have the values:
P=0.383998;
Q=0.121431;
S=0.805258;
   and the intermodulation term may be expressed as:

IM(t)=0.164803z(t)C_{P}D_{D}C_{D}. (13)

What is claimed is:

1. In a navigation system, a method of generating a spread-spectrum signal, comprising the steps:
providing a carrier wave and a modulation waveform, wherein said modulation waveform comprises an anti-phase linear combination of a BOC(1,1) waveform and a BOC(m,1) waveform, m representing an even integer number, said anti-phase linear combination being expressible as α·BOC(1,1)−β·BOC(m,1), wherein α and β are non-zero coefficients indicating the relative power split between said BOC(1,1) waveform and said BOC(m,1) waveform and wherein α and β are of same sign;
modulating said carrier wave with said modulation waveform.

2. The method as claimed in claim 1, comprising the step:
broadcasting said modulated carrier wave from at least one selected from a satellite and a pseudolite.

3. The method as claimed in claim 1, wherein said modulation waveform includes a pilot signal and a data signal, wherein one of said pilot signal and data signal comprises said anti-phase linear combination and wherein the other of said pilot and data signal comprises a BOC(1,1) waveform.

4. The method as claimed in claim 1, wherein said modulation waveform includes a pilot signal and a data signal, wherein one of said pilot signal and data signal comprises said anti-phase linear combination and wherein the other of said pilot signal and data signal comprises an in-phase linear combination of a BOC(1,1) waveform and a BOC(m,1) waveform, said in-phase linear combination being expressible as α·BOC(1,1)+β·BOC(m,1).

5. The method as claimed in claim 1, wherein m=6.

6. A method of determining a position, comprising a reception of a spread-spectrum signal generated according to the method as claimed in claim 1.

7. A spread-spectrum signal including a carrier wave and a modulation waveform, by which said carrier wave is modulated;
wherein said modulation waveform comprises an anti-phase linear combination of a BOC(1,1) waveform and a BOC(m,1) waveform, m representing an even integer number, said anti-phase linear combination being expressible as α·BOC(1,1)−β·BOC(m,1), wherein α and β are non-zero coefficients indicating the relative power split between said BOC(1,1) waveform and said BOC(m,1) waveform and wherein α and β are of same sign.

8. The spread-spectrum signal as claimed in claim 7, wherein said modulation waveform includes a pilot signal and a data signal, wherein one of said pilot and data signal comprises said anti-phase linear combination and wherein the other of said pilot and data signal comprises said BOC(1,1) waveform.

9. The spread-spectrum signal as claimed in claim 7, wherein said modulation waveform includes a pilot signal and a data signal, wherein one of said pilot signal and data signal comprises said anti-phase linear combination and wherein the other of said pilot signal and data signal comprises an in-phase linear combination of said BOC(1,1) waveform and said BOC(m,1) waveform, said in-phase linear combination being expressible as α·BOC(1,1)+β·BOC(m,1).

10. The spread-spectrum signal as claimed in claim 7, wherein m=6.

11. A spread-spectrum signal generator
providing a carrier wave and a modulation waveform, wherein said modulation waveform comprises an anti-phase linear combination of a BOC(1,1) waveform and a BOC(m,1) waveform, m representing an even integer number, said anti-phase linear combination being expressible as α·BOC(1,1)−β·BOC(m,1), wherein α and β are non-zero coefficients indicating the relative power split between said BOC(1,1) waveform and said BOC(m,1) waveform and wherein α and β are of same sign; and
modulating said carrier wave with said modulation waveform.

12. A satellite comprising a spread-spectrum signal generator as claimed in claim 11 and a transmitter broadcasting said modulated carrier wave.

13. A pseudolite comprising a spread-spectrum signal generator as claimed in claim 11 and a transmitter broadcasting said modulated carrier wave.
